(19) United States
(12) Patent Application Publication
(10) Pub. No.: US 2024/0386200 A1
(43) Pub. Date: Nov. 21, 2024

(54) METHOD AND SYSTEM FOR TOPIC MINING

(71) Applicant: BlackBerry Limited, Waterloo (CA)

(72) Inventors: Andrew James MALTON, Waterloo (CN); Deeksha CHANDOLA, Toronto (CA); Andrew Eric WALENSTEIN, Issaquah, WA (US)

(21) Appl. No.: 18/661,917

(22) Filed: May 13, 2024

Related U.S. Application Data
(60) Provisional application No. 63/502,204, filed on May 15, 2023.

(51) Int. Cl. G06F 40/279; G06F 40/30

(52) U.S. Cl. CPC G06F 40/279; G06F 40/30

(57) ABSTRACT

A method for natural language processing of a corpus of documents, the method including evaluating the corpus of documents to choose a plurality of topics, using the plurality of topics to generate a topic of topics; and assessing the topic of topics to determine a quality of the natural language processing of the corpus.

### CROSS REFERENCE TO RELATED APPLICATIONS

The present disclosure claims priority to U.S. Provisional Patent Application No. 63/502,204, filed May 15, 2023, the entire contents of which are incorporated herein by reference.

### FIELD OF THE DISCLOSURE

The present disclosure relates to natural language processing, and in particular relates to processing of a corpus of documents within a data lake.

### BACKGROUND

In Natural Language Processing (NLP), documents can be classified by finding specific sets of words in the document, and based on the sets of words found, the type of document may be identified. This is sometimes referred to as topic modelling, where the term ‘topic’ represents a set of words. In topic modeling, a model may be trained to automatically discover topics appearing in documents.

However, using NLP, one issue is matching documents to each other by content or subject. For example, customer service analysts may need to match customer requests to existing knowledge, and indeed to automate the process for either efficiency or as part of a customer-facing service.

### BRIEF DESCRIPTION OF THE DRAWINGS

The present disclosure will be better understood with reference to the drawings, in which:

FIG. 1 is a block diagram showing an example LDA pipeline.

FIG. 2 is a block diagram showing topic tuples assigned to a topic based on word probability estimates.

FIG. 3 is a block diagram of a process of using a known corpus of documents to define parameters for a topic mining algorithm.

FIG. 4 is a process diagram showing the use of a “topic of topics” to evaluate the quality of results from topic mining.

FIG. 5 is a block diagram of a simplified computing device capable of being used with the embodiments of the present disclosure.

### DETAILED DESCRIPTION

The present disclosure provides a method for natural language processing of a corpus of documents, the method comprising: evaluating the corpus of documents to choose a plurality of topics; using the plurality of topics to generate a topic of topics; and assessing the topic of topics to determine a quality of the natural language processing of the corpus.

The present disclosure further provides a computing device configured for natural language processing of a corpus of documents, the computing device comprising: a processor; and memory, wherein the computing device is configured to: evaluate the corpus of documents to choose a plurality of topics; use the plurality of topics to generate a topic of topics; and assess the topic of topics to determine a quality of the natural language processing of the corpus.

The present disclosure further provides a non-transitory computer readable medium for storing instruction code which, when executed by a processor of a computing device, cause the computing device to: evaluate the corpus of documents to choose a plurality of topics; use the plurality of topics to generate a topic of topics; and assess the topic of topics to determine a quality of the natural language processing of the corpus.

In natural-language applications, documents may need to be matched to each other by content or subject. In a data lake setting, where various kinds of enterprise data may be collected about systems, users, locations, and operational history, automated content identification is a promising technique for added value.

One way to identify content is by reducing documents to “topics” that suggest what they are “about” in a more concise way. The quality of identified “topics” or content, where quality is defined in the sense of reliable fitness for use, in matching or indexing content, is difficult to establish. This is because ultimately the topic is tied to the meaning and purpose of actual users.

Various techniques, such as statistical methods of evaluating “topics”, including “internal coherence”, “external coherence”, and “perplexity” have been attempted. However, despite their names, they are defined by probabilistic calculations, and do not depend on the meaning of the text.

In accordance with the embodiments of the present disclosure, systems and methods are provided which improve the quality of generating random data which conforms to the assumed statistical properties of natural language documents, and methods of evaluating topic mining algorithms' quality using these generated data. In particular, documents may be generated in accordance with the assumed probability distribution (a Dirichlet process). The resulting corpus of generated documents is represented in a hierarchical fashion in keeping with the expected structure of multi-author, multi-language, problem-description-solution conversations.

The size of the corpus, the number of documents, the overall vocabulary, and the number of “topics” are all able to be chosen as parameters of the generation; and the amount of variation in randomness is also controlled.

Prior methods of generation assumed that document topics are selected independently of each other in real documents. However, this is not in fact true for real documents.

Therefore, in addition to the typical parameters of such a generation, the present disclosure provides a method to add correlation between generated topics to the resulting corpus.

In particular, having specified the parameters of each individual topic, for such a generation, one or more “groupings” of topics is accepted (e.g. “cats and dogs are a group called pets; and cats and birds are a group called predation”). This accepted group is treated as a “topic of topics” because it is a finite set of groups, similar to how a topic is a finite set of words.

Subsequently, the topic of topics is parameterized like any other topic.

For generation, each document has a “topic of topics” selected first, and then, from that, the actual topics are generated according to it, and then used to generate words.

In particular, during topic mining, the quality of topics is not sufficiently discussed or checked. Information and trends would be good to know to validate the quality of the output.

Therefore, in accordance with the present disclosure, methods and systems are provided which may generate data while testing and evaluating parameter distributions.

For evaluating topic-mining algorithms, the methods and system of the present disclosure have a corpus of arbitrary size and vocabulary and topic complexity, whose actual topics (by vocabulary) and topic density (per document), and topic correlation (per document) are all known in advance. This is far different from the “usual” approach to quality evaluation of topic mining.

Based on this corpus, the present systems and methods may then execute an algorithm on the corpus, and compare the results of the algorithm with expected results. The algorithm may be a standard (e.g. from standard and open-source libraries) algorithm in some embodiments, or may be an adapted algorithm in some cases.

Topic mining is inherently a pseudo-random process which produces slightly (or wildly) different results each time it is executed, even on the same input. The present embodiments define and quantify the “stability” of the algorithms by estimating the likelihood that key topics are “found” and “similar” each time the process is executed.

Using the methods and systems of the present disclosure, various parameters can be defined. Specifically, the methods and systems can be used to quantify how much data is required on input. Specifically, the methods and systems can be used to quantify how much “training data” is needed to give reliable results on output.

A further parameter that can be defined is how large a vocabulary can be handled relative to the size of the corpus.

A further parameter that can be defined is how much reliance can be placed on the results of topic mining when applied to “real” (“wild”) data.

### Example Topic Mining

Topic mining or modeling is a type of statistical modeling for discovering the abstract “topics” that occur in a collection of documents. One example topic modeling system is Latent Dirichlet Allocation (LDA), which is used to classify text in a document to a particular topic. It builds a topic per document model and words per topic model, modeled as Dirichlet distributions. LDA is typically used on a corpus of documents which is monolingual. As used herein, a corpus of documents is a collection of documents, where each document is a collection of words/terms. As used herein, a “term” may consist of one word or a group of words.

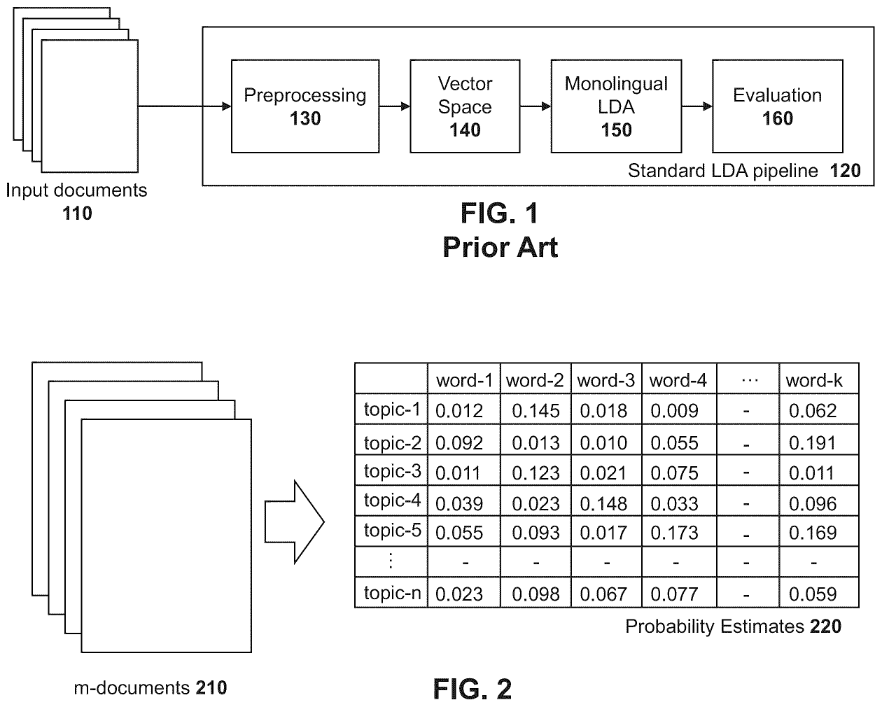

Reference is now made to FIG. 1. The example of FIG. 1 shows a typical LDA structure in which a corpus of input documents 110 is provided to a standard LDA pipeline 120. In some embodiments, the corpus of input documents 110 may be chosen based on various criteria. However, for the purpose of FIG. 1, the selection of the corpus of input documents 110 can be done based on any factors or criteria, or the corpus of documents may exist in a data lake and not be filtered.

Each document is provided to the standard LDA pipeline 120. The text of each document may then be subjected to preprocessing at block 130. Preprocessing may include tokenization, lemmatization, stemming, and removal of stop words, among other preprocessing steps. Thus, at block 130 the preprocessing may make any pluralized words singular; convert any verb to the present tense; remove certain words such as “the”, “a”, “and”, among others; words in the third person may be changed to the first person; all words may be converted to lowercase; punctuation may be removed; words may be reduced to their root form; very common words may be pruned; hypertext markup language (html) tags may be removed; special characters may be removed; among other options for preprocessing.

The preprocessed dictionary may then be provided to a vector space block 140. Vector space block 140 may create vectors for various topics. For example, referring to FIG. 2, a plurality of documents 210 can be provided through the LDA model and thereafter each topic is represented by a tuple of words, where each word has a probability estimate 220. The probability estimates for each topic would add to one, typically, and could indicate the most prevalent words for such topic.

Referring again to FIG. 1, from the vector space block 140, the process proceeds to block 150 in which a monolingual LDA may be applied to each document. In particular, each document is represented by a certain number of topics, as determined by block 150. The topics for each document may be chosen based on the prevalence of words/terms in the document and the associated prevalence of such words/terms in the topic. In some cases, a defined number of topics may be chosen for each document.

The process then proceeds to block 160 in which an evaluation of the LDA model may be made. The evaluation may be based on one or more criteria to see how well the model classifies documents.

Based on FIG. 1, a corpus of documents can therefore be processed using an LDA model.

In practice, an LDA model typically may include the following:
a. M denotes the number of documents;
b. N[i] is number of words in a given document;
c. alpha is the parameter of the Dirichlet prior on the per-document topic distributions;
d. beta is the parameter of the Dirichlet prior on the per-topic word distribution;
e. theta[i] is the topic distribution for document i;
f. q[k] is the word distribution for topic k;
g. z[i][j] is the topic for the j-th word in document i;
h. w[i][j] is the specific word;
i. K is the number of topics; and
j. V is the number of words in the vocabulary.

The model may be created using a Dirichlet distribution generative process. In this generative process, a topic-group distribution is a point in the G-simplex. The size of a group is the number of topics in it and the count of a group is the number of documents assigned to it. The topic distribution for each document, denoted at theta[i] for document i, is a point in the K-simplex.

For word distribution for each topic, phi[j] may be denoted as the word distribution for topic j. A word distribution is a point in the V-simplex.

With regard to word choice, if docs[i] becomes a sequence of N[i] words chosen from document i's topic group, then z[i][j] is the number of words in document i that comes from topic j. In this case, w[i][j][k] may be the number of instances of word k appearing in document i because of topic j. This may be rolled up to docs[i][j] which is the word index number at position j in document i.

### Adding Correlation Between Generated Topics and Resulting Corpus

A known corpus of documents may be created and an LDA or other topic mining algorithm, such as those described above in FIGS. 1 and 2, may be performed on the corpus. Specifically, the actual topics (by vocabulary) and topic density (per document), and topic correlation (per document) are all known in advance on the corpus.

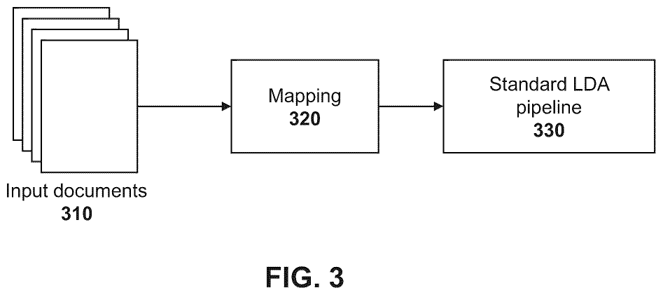

Thus, referring to FIG. 3, the known corpus of documents 310 are provided to the topic mining algorithm 320.

The topic mining algorithm may then be evaluated with the expected results at block 320. This can be used to define how much data is required on input (how much “training data”) is needed give reliable results on output. It can further be used to define how large a vocabulary can be handled relative to the size of the corpus. The results can be further used to define how much reliance can be placed on the results of topic mining when applied to “real” (“wild”) data.

After this, the corpus of real data can be extended to meet the parameters defined based on the results at block 330.

### Quality

Topic mining, such as LDA models, needs to produce a coherent set of topics. In other words, the LDA model needs to produce a set of words describing a topic that is semantically connected. In this regard, a topic coherence metric may be used to determine the degree of semantic similarity between high scoring words in a topic.

A further evaluation of quality may be the level of inferential power achieved by the candidate model. Specifically, LDA models are useful when they can correctly guess one or more of the higher weighted topics of a new, unseen document. Specifically, in LDA each document will typically have a probability or weighting for the topics in the corpus associated with that document, and the higher probability or weighting scores for topics in the document may be indicative of the topics of the document. In one case a document having “mostly” topic 1 (of say, ten topics in the corpus) might have a topic assignment of (t1: 90%, t2: 8%, t2: 1.9%, t4 . . . t10: less than 0.1%). Thus, the level of inferential power can be based on whether the model can correctly guess the one or more most highly weighted topics. Therefore, a quality metric may be a “perplexity” score, where the model can be evaluated on how perplexed it becomes when it encounters words of a new, unseen document.

A further evaluation of quality maybe the text-log (natural-computer language) alignment achieved by the candidate models. In particular, LDA may be used to produce topics that contain both natural language words and computer language words. In this regard, a quality metric may include the level of alignment.

Hyperparameter tuning, for example using the techniques described by J. Ansel et al, “An extensible framework for pro-gram autotuning”, proceedings of the 23rd International Conference on Parallel Architectures and Compilation, PACT '14, Association for Computing Machinery, New York, NY, USA, 2014, p. 303-316, the contents of which are incorporated herein by reference, may be used to tune the LDA models.

Utilizing the above evaluation criteria, when the known (real-world/wild) corpus contains multi-lingual topics (either multiple natural languages or a combination natural and computer (log) languages) a topic mining method could be evaluated in the same way, specialized to this kind of corpus. For example, the vocabularies of the two or more languages in the known corpus are identified separately, parameters for the topics identified separately in each language are obtained separately, and the two or more language topics are grouped for generating new corpus.

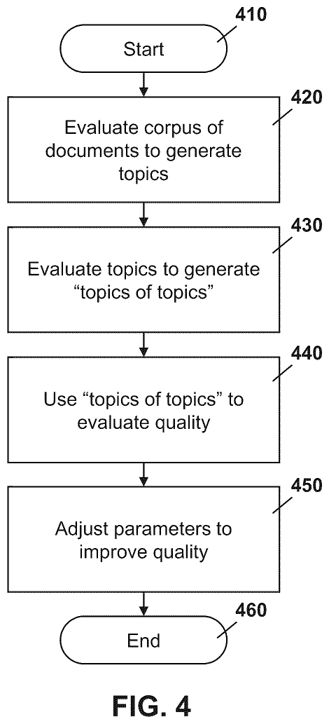

Reference is now made to FIG. 4. The process of FIG. 4 starts at block 410 and proceeds to block 420 in which a corpus of documents can be evaluated for topics. This is referred to as topic mining.

In particular, as in prior LDA models, documents within a corpus are evaluated and topics are chosen, where probabilities are assigned to each topic. The probabilities for the collection of topics for each document adds to a value of 1.

The process then proceeds to block 430. While topics are chosen on a word by word basis and no correlation exists between topics. However, in real data sets, a “topic of topics” provides a more realistic distribution. Therefore, in accordance with the embodiments of the present disclosure, at block 430 the list of topics can be evaluated using similar topic mining techniques to generate a “topic of topics”. This “topic of topics” may be considered as one more topics in the collection of topics.

The topic of topics allows for the quality of the processing of the corpus at block 420 to be evaluated at block 440. For example, the topic of topics allows a probability distribution of the probability distribution to be found. Quality evaluation is described above. This can be compared with an expected result based on a training set.

If the quality is insufficient, such as for example producing results below a certain threshold, then the process at block 450 may allow parameter within the topic mining algorithm to be modified to ensure the quality of topic mining is sufficient. Examples of such parameters are described above.

The process may then proceed to block 460 and end.

The above may be done in various ways. In one example, a script such as python script for the generation of a topic of topics may be run which generates a corpus of pseudo-documents with a generalized Dirichlet topic model, suitable for testing topic mining applications.

A corpus is a collection of threads; each thread is a collection of posts; each post is a collection of paragraphs; the paragraphs are the documents.

The documents are generated using three kinds of categorical distribution: one kind (beta) generates words from a vocabulary; one kind (alpha) generates topics from a topic group; and one kind (gamma) generates topic groups from a topic-group list.

The generation may occur according to the following procedure: First, the vocabulary is defined by selecting V words from a dictionary. (The literal words are not significant, and WORD00 WORD01 etc. may be used if there is no dictionary available. The number V may be specified on a command line.)

Second, K topics are defined: each topic is a distribution of the words, and so K categorical distributions are selected using the beta parameter(s). (The number K may for example be specified on a command line, or may be the number of topics mentioned in topic groups on the command line.)

Third, G topic-groups are defined: each group is a distribution of the topics, and so G categorical distributions are selected using the alpha parameter(s). (The number G of topic-groups may be implicit on the command line, for example from parameters such the topic-group (e.g. topics to associate in a document), number-of-topics, and single (e.g. every implicit topic is in a group on its own) options. If none of these options is used, G is 1 and the one group may contains all the topics.)

The parameters actually used to define a topic-group may be the alpha parameters, except that topic positions corresponding to topics_not_in a group are replaced for that group by a very small number, so that those topics are almost-certain_not_to be chosen when that topic distribution is used.

Fourth, a single topic-group distribution is selected using the gamma parameter(s).

The generation of the actual documents proceeds from the above data as follows:
a. The topic-group distribution is used M times, to choose a topic-group (a topic distribution) for each document.
b. Each document's topic distribution is used N times, to choose a topic (a word distribution) for each of its word positions.
c. The topic of each word position of each document is then used once to choose a word for that position.

Note that topics all “overlap” because they have a common vocabulary. Also topic-groups can be specified to “overlap” and have topics in common. (There is only one topic-group distribution, so no overlaps there.)

If topic grouping is not used, there may be one unique topic group enclosing all the topics and assigned to every document. This then devolves to the “usual” Dirichlet topic model.

Further, there is no word-sequential correlation: the order of words in a document, or of documents in the corpus, contains no information at all. The order in the generated corpus is randomized, but (since this takes time) it can be suppressed in some cases.

Based on this, the script may therefore be used to generate a topic of topics as described above with regards to FIG. 4.

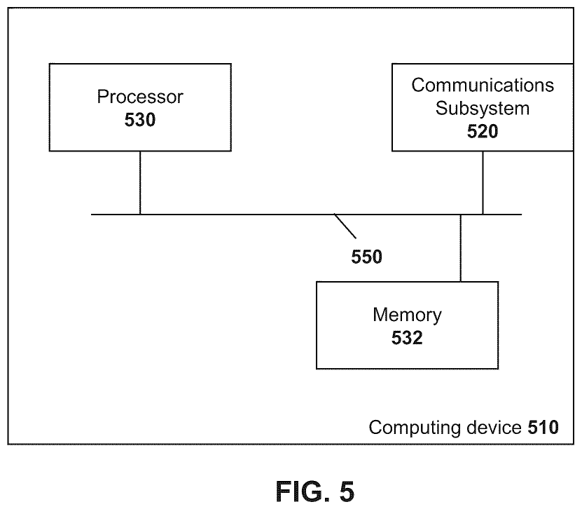

The above models may be implemented using any computing device or combination of computing devices. One simplified diagram of a computing device is shown with regard to FIG. 5. The computing device of FIG. 5 could be any fixed or mobile computing device.

In FIG. 5, device 510 includes a processor 520 and a communications subsystem 530, where the processor 520 and communications subsystem 530 cooperate to perform the methods of the embodiments described above. Communications subsystem 530 allows device 510 to communicate with other devices or network elements and may vary based on the type of communication being performed. Further, communications subsystem 530 may comprise a plurality of communications technologies, including any wired or wireless communications technology.

Processor 520 is configured to execute programmable logic, which may be stored, along with data, on device 510, and shown in the example of FIG. 5 as memory 532. Memory 532 can be any tangible, non-transitory computer readable storage medium which stores instruction code that, when executed by processor 520 cause device 510 to perform the methods of the present disclosure. The computer readable storage medium may be a tangible or in transitory/non-transitory medium such as optical (e.g., CD, DVD, etc.), magnetic (e.g., tape), flash drive, hard drive, or other memory known in the art.

Alternatively, or in addition to memory 532, device 510 may access data or programmable logic from an external storage medium, for example through communications subsystem 530.

Communications between the various elements of device 510 may be through an internal bus 550 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems, or methods with insubstantial differences from the techniques of this application as described herein.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation descried above should not be understood as requiring such separation in all implementations, and it should be understood that the described program components and systems can generally be integrated together in a single software product or packaged into multiple software products.

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps are not implied by the order they appear in the claims.

When messages are sent to/from an electronic device, such operations may not be immediate or from the server directly. They may be synchronously or asynchronously delivered, from a server or other computing system infrastructure supporting the devices/methods/systems described herein. The foregoing steps may include, in whole or in part, synchronous/asynchronous communications to/from the device/infrastructure. Moreover, communication from the electronic device may be to one or more endpoints on a network. These endpoints may be serviced by a server, a distributed computing system, a stream processor, etc. Content Delivery Networks (CDNs) may also provide may provide communication to an electronic device. For example, rather than a typical server response, the server may also provision or indicate a data for content delivery network (CDN) to await download by the electronic device at a later time, such as a subsequent activity of electronic device. Thus, data may be sent directly from the server, or other infrastructure, such as a distributed infrastructure, or a CDN, as part of or separate from the system.

Typically, storage mediums can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly a plurality of nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method for natural language processing of a corpus of documents, the method comprising:
evaluating the corpus of documents to choose a plurality of topics;
using the plurality of topics to generate a topic of topics; and
assessing the topic of topics to determine a quality of the natural language processing of the corpus.

2. The method of claim 1, further comprising assigning a probability to each topic from the plurality of topics.

3. The method of claim 2, wherein a sum of probabilities from the assigning adds to one.

4. The method of claim 1, wherein the topic of topics provides a probability distribution of a probability distribution of the plurality of topics.

5. The method of claim 1, wherein the quality comprises a topic coherence metric used to determine a degree of semantic similarity between words in each topic.

6. The method of claim 1, wherein the quality comprises a perplexity score when the natural language processing is applied to a new document.

7. The method of claim 1, wherein the quality comprises alignment between multiple languages in the corpus.

8. The method of claim 1, further comprising:
checking the quality against a training set quality;
when the quality is less than the training set quality, modifying at least one parameter within the natural language processing; and
repeating the evaluating, using and assessing.

9. The method of claim 1, wherein the evaluating uses Latent Dirichlet Allocation (LDA) on the corpus of documents to choose the plurality of topics.

10. The method of claim 9, wherein the using uses Latent Dirichlet Allocation (LDA) to generate the topic of topics.

11. A computing device configured for natural language processing of a corpus of documents, the computing device comprising:
a processor; and
memory,
wherein the computing device is configured to:
evaluate the corpus of documents to choose a plurality of topics;
use the plurality of topics to generate a topic of topics; and
assess the topic of topics to determine a quality of the natural language processing of the corpus.

12. The computing device of claim 11, wherein the computing device is further configured to assign a probability to each topic from the plurality of topics.

13. The computing device of claim 11, wherein the topic of topics provides a probability distribution of a probability distribution of the plurality of topics.

14. The computing device of claim 11, wherein the quality comprises a topic coherence metric used to determine a degree of semantic similarity between words in each topic.

15. The computing device of claim 11, wherein the quality comprises a perplexity score when the natural language processing is applied to a new document.

16. The computing device of claim 11, wherein the quality comprises alignment between multiple languages in the corpus.

17. The computing device of claim 11, wherein the computing device is further configured to:
check the quality against a training set quality;
when the quality is less than the training set quality, modify at least one parameter within the natural language processing; and
repeat the evaluating, using and assessing.

18. The computing device of claim 11, wherein the computing device is configured to evaluate by using Latent Dirichlet Allocation (LDA) on the corpus of documents to choose the plurality of topics.

19. The computing device of claim 18, wherein the computing device is configured to use Latent Dirichlet Allocation (LDA) to generate the topic of topics.

20. A non-transitory computer readable medium for storing instruction code which, when executed by a processor of a computing device, cause the computing device to:
evaluate the corpus of documents to choose a plurality of topics;
use the plurality of topics to generate a topic of topics; and
assess the topic of topics to determine a quality of the natural language processing of the corpus.
